(19) United States
(12) Patent Application Publication
(10) Pub. No.: US 2006/0009716 A1
(43) Pub. Date: Jan. 12, 2006

(54) METHOD AND APPARATUS FOR PREVENTING A HEART ATTACK WHEN EXPERIENCING ANGINA

(76) Inventor: Steven G. Darling, Ocean Ridge, FL (US)

Correspondence Address: MALIN HALEY AND DIMAGGIO, PA, 1936 S ANDREWS AVENUE, FORT LAUDERDALE, FL, 33316, US

(21) Appl. No.: 11/160,239

(22) Filed: Jun. 15, 2005

Related U.S. Application Data
(60) Provisional application No. 60/521,835, filed on Jul. 8, 2004.

(51) Int. Cl. A61H 1/00

(52) U.S. Cl. 601/2

(57) ABSTRACT

A method and portable apparatus to be carried by a potential user for preventing a heart attack or reducing the effect of a heart attack that provides warning through the person experiencing chest pain or angina by applying a narrow beam (circle of one inch diameter) directly to the chest above the heart with a vibrational device that is sized in diameter to be directed to a very small area of the heart muscle for maximum energy transfer to the patient. The purpose of the method and apparatus is to stimulate blood flow to the heart muscle to prevent the heart attack.

### FIELD OF THE INVENTION

This invention relates to a method and apparatus for immediate treatment of angina with the intention of preventing a myocardial infarction or at least minimizing the percentage of infracted myocardium resulting from lack of perfusion. The method includes providing highly focused, highly directional high-energy mechanical vibration through the chest wall into the occluded coronary vessels of the person experiencing the angina.

### DESCRIPTION OF RELATED ART

Each year in the United States, heart attack is one of the leading causes of death. Often times, the prelude to a heart attack in a human being is the experience by the individual of chest pain or angina. However, the response time in calling for an ambulance or emergency medical service can be sufficiently long that a victim may experience a severe heart attack, the damage of which is irreversible or even fatal well before medical service can arrive. There is a saying with regard to heart attacks that “time is muscle,” meaning the longer the delay in perfusion, the more heart muscle will die.

It is known in the prior art that there are methods for attempting to detect and treat cardiac events. U.S. Patent Application Publication 2003/0149423 published Aug. 7, 2003 discloses methods for detecting an acute myocardial infarction (i.e. heart attack) at the earliest possible time that allows a patient to promptly be warned that the patient should immediately seek medical care. These methods are complicated and require implants in a person and self injection of medication. Other implantable devices as shown in U.S. Pat. No. 5,433,731 issued Jul. 18, 1995 to Hoegnelid, et al. disclose a mechanical defibrillator that can be used to employ shock pulse generation for delivering defibrillation shock to a heart. Again, this requires a medical implant in the patient. U.S. Pat. No. 6,387,109 discloses a method and a device for improving blood flow to the heart of a patient. However, the device uses a catheter that must be implanted into the patient. One of the problems with the prior art is that the solutions do not provide for immediate relief that a potential heart attack victim can provide without prior implants or incisions. The present invention directs mechanical energy to the heart muscle (either mechanical, sonic or ultrasonic) by placing the vibration device directly over the heart muscle on the exterior of the skin to instantly increase blood flow in the arteries in the heart muscle to prevent a heart attack when the patient or individual experiences the onset of a heart attack. The vibrational energy can be focused by the size and shape of the transducer and the frequency (wave length) of the ultrasonic energy.

The treatment of chronic angina is dealt with the device shown in U.S. Pat. No. 6,790,187. In this device, ultrasonic energy is directed toward the vasculature of the heart. This is to increase the flow rate or profusion of circulating blood. However, one of the drawbacks of the device shown in U.S. Pat. No. 6,790,187 is that the ultrasonic beam and energy divergence is such that the energy is directed over the entire heart area (or greater) at the same time. The problem with this approach is that a larger device is required and the energy is not concentrated or focused to the specific area that needs the blood profusion. In the present invention, the highly directional focused beam of energy is much smaller than the size of the whole heart. A very lightweight energy device is used that can be manually moved about easily and redirected towards the heart until the specific area of the heart that needs profusion receives the ultrasonic energy which can be felt by the patient. This can be self-administered during angina which allows the patient to move a small focused beam of energy about in the direction of the heart until the patient feels relief at which point the beam would be continuously directed at that part of the heart area.

This vibrational energy will be applied externally (superficially) and the focused energy will be transmitted through the chest wall and into the coronary vessels of the heart. Angina or chest pain is related to the blockage of these coronary arteries during which the oxygen-carrying red blood cells are unable to reach the muscle tissue of the heart. When this occurs, the heart muscle or myocardium infarcts or dies resulting in what is commonly referred to as a heart attack or myocardial infarction. As vibrational energy is transmitted to the blood cells of the coronary vessels of the heart, the vibrational energy will decrease the blood cells' cohesive properties (tendency of the blood cells to stick to each other) and also will decrease the blood cells' adhesive properties (tendency of the blood cells to stick to the walls of the coronary vessels). This will ultimately result in the increased blood flow to the myocardial tissue or heart muscle thus preventing infarction to these tissues. Other methods of increasing myocardial profusion are commonly accepted i.e. “blood thinners” which also decrease the cohesive and adhesive properties of the blood. Unfortunately, these medications have a systemic response which results in increased bleeding times and bruising, both of which are generally considered to be disadvantages. Nitroglycerin, a common approach to the treatment of angina, results in vasodilation often with severe headaches as a side effect. The ability of the present invention and the apparatus and method herein to be site specific should not be overlooked. It should be noted, however, that one or all of these methods could be used in conjunction with the other.

### SUMMARY OF THE INVENTION

A method and apparatus for preventing a heart attack in a human being that is evidenced by chest pain or angina by providing mechanical, ultrasonic vibration in a narrow focused highly directional beam much smaller in area than the heart muscle over the heart area of the person experiencing angina for a period of time to increase blood circulation in the heart muscle through mechanical or ultrasonic vibration. The vibrational energy is transmitted and directed through the chest from the exterior skin area of the chest. The vibration can be applied instantly by the person experiencing the angina. By applying the mechanical or ultrasonic vibration directly to the skin ensures maximum transfer penetration of the vibrations through the skin and down into the chest area directly to the heart and surrounding the heart increasing blood flow in the heart arteries.

The directional beam of ultrasonic energy is sized to be approximately a circle that is 2.5 centimeters in diameter. Using an ultrasonic frequency of 25,000 hertz (a wave length of 5.76 centimeters and a transducer face that is circular having 2.54 centimeters, a highly directional beam of ultrasonic energy is achieved. The operator of the device which could include the patient can then move the very lightweight device about the chest cavity area periodically until an area is found that greatly reduces the angina which would indicate that would be the specific area where the energy is being directed against the heart of most concerned requiring blood profusion. By using the highly directional beam of energy, more energy can be transmitted and radiated to the area of greatest concern. The device itself, including the transducer, can be very lightweight and handheld.

The vibrational device is ultrasonically vibrated using an ultrasonic transducer head that creates ultrasonic vibrations that can be transmitted through the skin chest area directed and focused to the heart muscle. A small transducer head is elected with the desired wave length to achieve a focused beam much smaller than the heart muscle. The ultrasonic frequency is selected for maximum energy travel through the patient's body to the heart muscle. The vibrational device is placed directly over the heart muscle in the preferred operation and moved about periodically to find a location that greatly reduces angina.

In operation, the person experiencing chest pain or angina or another operator grasps the vibrational device transducer and positions the device directly over the heart muscle against the chest skin and turns the power switch on, transmitting high frequency focused highly directed vibrational energy through the skin area directly into the heart muscle area. The vibrational device can be applied in different heart areas because the beam is focused for a few minutes until a location is found that reduces angina to increase blood flow into the heart muscle through the vibration action. In an alternate embodiment, a person with the victim experiencing angina could apply the mechanical vibrator directly to the chest of the victim.

It is believed that using this method and apparatus at the onset of chest pain or angina could greatly reduce the chances of getting a heart attack if sufficient ultrasonic energy is transmitted directly to the heart muscle to increase the blood flow to prevent a myocardial infraction.

It is an object of this invention to provide a method to immediately and simply prevent or alleviate the effect of the heart attack on a human being when the person receives an onset warning such as chest pain or angina.

It is another object of this invention to provide a relatively non-complex, low cost method of alleviating and preventing heart attacks using an ultrasonic vibrator that can be administered and adjusted in location and direction to different areas of the heart muscle by the person experiencing angina or by a third party until a spot is found that reduces angina.

In accordance with these and other objects which will become apparent hereinafter, the instant invention will now be described with particular reference to the accompanying drawings.

### BRIEF DESCRIPTION OF THE DRAWINGS

FIG. 1 shows a flow chart of the method of the current invention.

FIG. 2 shows a schematic diagram of a vibrational device that can be used with the present invention.

FIG. 3 shows a perspective view of the present invention.

FIG. 4 shows a bottom plain view of the present invention.

FIG. 5 shows a bottom plain view of the present invention with the top cover removed showing the insides of the device.

### DETAILED DESCRIPTION

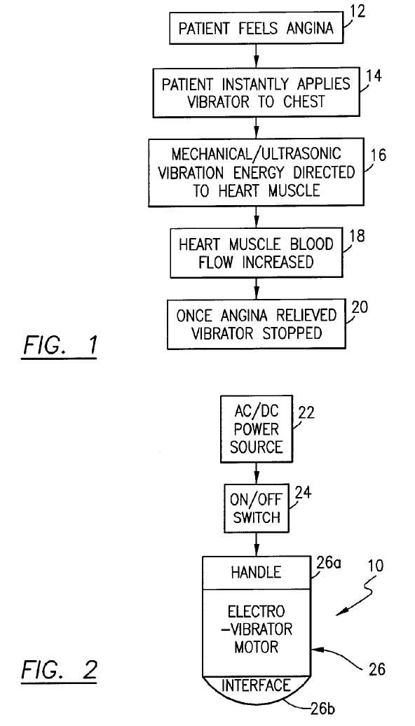

Referring now to FIGS. 1 and 2, the present invention 10 provides for a method of alleviating or preventing a heart attack in a human being through the application of high frequency mechanical vibration to a person that is experiencing the warning of a heart attack in the form of chest pain or angina. At the onset of chest pain or angina 12, the victim immediately manually applies vibrational energy to the victim's outer skin 14 and 16 from a specially shaped transducer 26 connected to an ultrasonic vibrator. The power is turned on and the device 10 is placed directly over the heart area of the patient 16. The vibrator interface 26b, which could be hard rubber or metal, is shaped and sized approximately as a circle with a diameter of one inch or 2.54 centimeters, much smaller than the diameter of the human heart. The vibrational pattern is transmitted in spherical waves or flat waves based on a circular disk-shaped vibrator and interface that may be slightly curved. The vibrational energy is focused in a narrow ultrasonic beam (a circle of one inch diameter) and transmitted through the skin to apply maximum directional vibrational energy to a small area of the heart muscle to result in blood stimulation 18 of the heart muscle during the vibrational application. Various wave patterns can be selected that would result in the maximum amount of energy transferred through that area of the human body from directly over the heart muscle. Other areas of the body directionally related to the heart muscle may be selected based on medical evidence that could also be the location to transmit high energy mechanical vibration to the heart to increase blood stimulation and blood flow to prevent the heart attack. This focused vibrational beam can be moved about the chest and heart area until a spot is achieved that reduces angina. The application could also be applied by a third party who is with the person experiencing angina.

The ultrasonic device 10 is shown with an interface 26b that is shaped to provide the maximum directional ultrasonic energy to a small area the heart muscle such as a circle one inch in diameter. In this particular case, the transducer element 26 that vibrates is a circularly shaped plate or disk that has a flat surface or a spherical arc for transmitting the ultrasonic energy in a circular or spherical wave pattern to a specific area of the heart muscle.

The ultrasonic vibrator motor 26 includes an A.C. or D.C. electric motor attached to the transducer 26 (interface). The preferable source of power is a pair of batteries but can be conventional 110 volt A.C. from a wall receptacle with an electrical chord attached to the electric motor and a conventional plug. The power source to the motor could be D.C. from one or more batteries mounted in the same housing as the ultrasonic transducer eliminating the need for a chord or external power source. The ultrasonic energy can be transmitted from interface 26b. The device 10 includes an on/off switch 24 and finger straps.

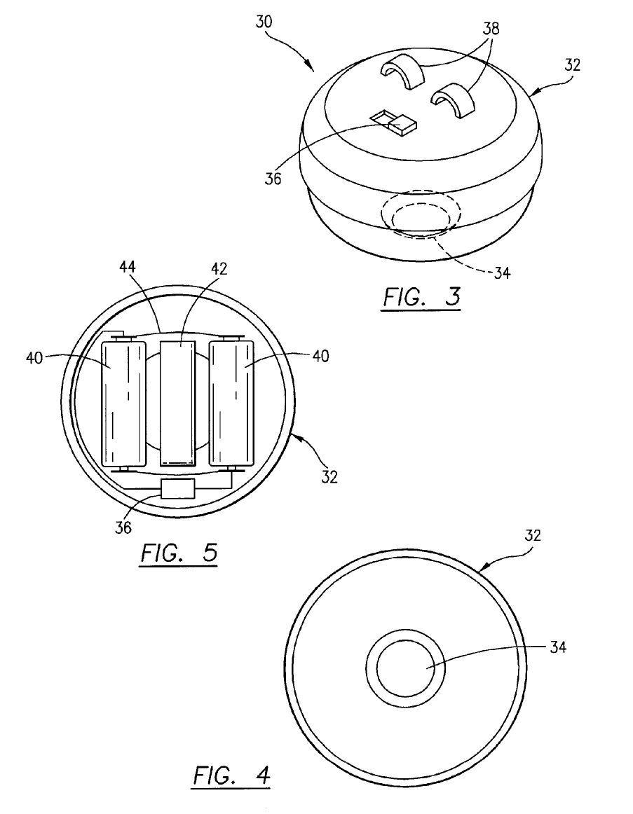

Referring now to FIG. 3, an embodiment of the present invention is shown as a portable energy transmitting device 30 that can radiate a focused beam of ultrasonic energy that would be approximately a circle having a diameter of one inch or 2.54 centimeters when the energy arrives at the heart muscle inside a normal human being. As shown in FIG. 3, device 30 is portable, is quite small, includes a pair of finger straps 38 that can be used to hold the device in one's hand while in use. The device includes an on/off switch 36 to turn on the ultrasonic device in order to generate the ultrasonic beam. The housing 32 could be somewhat cylindrical and made of a suitable hard plastic material. At the bottom part of the housing is a ultrasonic transducer 34 made of a suitable plastic or rubber material that is in direct contact with the ultrasonic energy vibrator shown in FIG. 5, element 42, that actually provides the ultrasonic energy. For this particular device, 25000 hertz frequency is used which is approximately a 5.76 centimeter wave length. This will approximate an aperture size or area of energy focused beam of approximately a circle having 2.5 centimeters or which is about one inch in diameter for the circle.

FIG. 4 shows the transducer 34 as being a circle in order to transmit a substantially circular beam. The transducer is rested on the chest in the general area of the heart and the beam is directed down inwardly to the heart muscle. Note that the transducer size being approximately one inch in diameter coupled with the frequency and wave length of 5.76 centimeters will produce a divergent beam of approximately 2.54 centimeters diameter circle that is directed to the heart. This amount of energy and area is significantly smaller than the heart muscle itself in a normal human being which is several centimeters large. Therefore, the beam of energy of ultrasonic energy used in this particular device is very narrow compared to the size of the heart and can focus on a specific area of the heart depending on where part of the chest the user directs the energy beam. It is the purpose of this invention to allow either the actual person experiencing angina to utilize the device and move the beam generator about the chest at different parts of the heart muscle until angina relief is felt since the beam will be concentrating on the area that needs the blood profusion. In order to find this particular area of concern on the heart muscle, the device can be moved slowly to different areas on the chest until an area is found where the angina subsides or is greatly reduced. Instead of bathing the entire heart muscle at one time with much less overall energy, using the present invention, a small device with a higher energy beam can be focused to specific small areas of the heart until that one area is found that alleviates angina and increases blood profusion to prevent the heart attack.

FIG. 5 shows the inside of housing 32 and includes a pair of batteries 40 that are electrically by circuitry 44 to an ultrasonic energy wave generator that itself is connected to the transducer 34 for providing the ultrasonic energy necessary. Switch 36 can be turned on and off which turns off the ultrasonic transducer. The ultrasonic transducer can be conventional and creates ultrasonic wave energy from electricity provided by the batteries. The device could have an additional cord plug in for home use while with batteries it can be carried portably on the person at all times so that it is available should angina arise.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for preventing a heart attack in a human being when the human being is evidencing chest pain or angina indicative of a heart attack by providing a focused beam of ultrasonic energy much smaller in area than the human heart directly to the chest above the heart area of the person experiencing angina to induce additional blood circulation in a specific small area of the heart muscle.

2. A device for stimulating blood flow in the arteries of the heart muscle upon the onset of angina pain to prevent a heart attack comprising:
an ultrasonic transducer having an end face to generate a focused beam much smaller than the human heart at a predetermined ultrasonic frequency;
a power source connected to said ultrasonic transducer;
an on/off switch connected to said power source and said ultrasonic transducer to turn said electric motor on or off; and
said transducer producing at least 20,000 Hz frequency of ultrasonic energy in a narrow beam.

3. A device as in claim 1, including:
an ultrasonic wave generator for generating ultrasonic waves above 20,000 Hertz connected to said transducer for stimulating one or more heart arteries with a highly directional focused beam of ultrasonic energy to alleviate angina and prevent a heart attack.

4. A device as in claim 1, including:
wherein the ultrasonic frequency is about 25,000 Hz to best reduce angina pain while experiencing angina.

5. A method of reducing angina comprising the steps of:
(a) placing an ultrasonic energy vibrator with a transducer on the chest of a person experiencing angina;
(b) directing said ultrasonic wave energy in a highly directional narrow beam much smaller in area than the heart muscle above 5000 Hz to one or more arteries of the heart muscle; and
(c) moving the vibrator to select the best spot on the heart muscle that reduces angina pain by the user to prevent heart attach to compensate for individuals of different sizes and physiological differences.

6. A method as in claim 4, including the steps of:
(d) providing ultrasonic energy above 20,000 Hz to said transducer.

7. A method as in claim 5, including the steps of:
sizing the transducer surface area and frequency to direct a small area beam of vibrational energy to a very specific small area of the heart muscle.

8. A device as in claim 1, wherein:
said power source is a battery and said device is portable and hand held.

9. A method for preventing a heart attack comprising the steps of:
(a) at the first sign of angina, placing a source of ultrasonic energy above 5000 Hz over the chest cavity in a highly direction small area beam much smaller than the heart muscle;
(b) stimulating arteries in a very small area of the heart muscle with ultrasonic energy to increase blood flow to reduce angina; and
(c) selecting the best location on the chest for directing the beam by the user to reduce angina.

10. A method as in claim 9, comprising the additional step of:
(d) providing a source of mechanical energy above 20,000 Hz.
